(19) United States
(12) Patent Application Publication
(10) Pub. No.: US 2023/0299592 A1
(43) Pub. Date: Sep. 21, 2023

(54) ENERGY STORAGE CHILD-MOTHER MACHINE SYSTEM AND CONTROL METHOD THEREOF

(71) Applicant: Zhongshan Shengyuan Technology Co., Ltd, Zhongshan City (CN)

(72) Inventor: Baozhou Xu, Zhuhai City (CN)

(21) Appl. No.: 17/660,492

(22) Filed: Apr. 25, 2022

(30) Foreign Application Priority Data
Mar. 17, 2022 (CN) 202210263550.7

(51) Int. Cl. H02J 7/00; H02J 50/10

(52) U.S. Cl. CPC H02J 7/00034; H02J 7/0013; H02J 7/007194; H02J 50/10; H02J 7/0047; H02J 7/0063; H02J 2207/30; H04W 88/10

(57) ABSTRACT

The present disclosure provides an energy storage child-mother machine system, which includes energy storage power mother machine, plurality of energy storage power child machines matching with energy storage power mother machine. Under normal state, energy storage power mother machine is connected to power, stores energy to charge the energy storage power child machines; specifically, charge slots or positions maybe arranged on energy storage power mother machine, energy storage power child machines maybe placed on the charge slots or charge positions. When going out, only energy storage power child machines can be detached, charged energy storage child machines are carried out, convenient to supply power by energy storage power child machines anytime. Energy storage power child machines can be used when needed, put back for charging to adapt to using demands in different scenarios; the using flexibility is greatly improved, the energy storage power child machines are convenient and intelligent.

### CROSS-REFERENCE TO RELATED APPLICATIONS

This is a U. S. patent application which claims the priority and benefit of Chinese Patent Application Number 202210263550.7, filed on Mar. 17, 2022, the disclosure of which is incorporated herein by reference in its entirety.

### TECHNICAL FIELD

The present disclosure relates to the technical field of energy storage, in particular to an energy storage child-mother machine system and a control method thereof.

### BACKGROUND

As the current hot emerging field, the energy storage technology is widely applied in all walks of life. Specifically, with the rapid development of the global economy, the continuous improvement of people's living standard, the blowout improvement of tourist economy in Chinese holidays and festivals, and the gradually increased time for outdoor road trip and outdoor gatherings, people have more opportunities to use portable electronic devices. However, these mobile electronic devices cannot be used outdoors for a long time due to the limitation of the battery capacity, and it is impossible to configure a standby battery for each piece of outdoor equipment, thus the high cost and inconvenience will be caused. Therefore, a portable energy storage box is born, but the current portable energy storage box only applies to scenarios with low power consumption and low power requirement due to the single function and a certain using limitation, so a novel child-mother machine system is urgently needed to solve the above problems.

### SUMMARY

The present disclosure aims at solving at least one of the technical problems existing in the prior art. Therefore, the present disclosure provides an energy storage child-mother machine system and a control method thereof.

The technical solution adopted to solve the technical problem in one embodiment of the present disclosure is as follows:

An energy storage child-mother machine system, including an energy storage power mother machine and N energy storage power child machines corresponding to the energy storage power mother machine, and N is greater than or equal to 1; any one of the energy storage power child machines may be disconnected or in power supply and double-directional communication connection with the energy storage power mother machine, and the energy storage power mother machine and the energy storage power child machines may be subjected to the self-battery management; and the energy storage power mother machine may be connected to an external circuit for charging and storing energy and supply power to the energy storage power child machines after connecting to the energy storage power child machines, and the energy storage power child machines may accept the power supply and store energy, and supply power to the external circuit.

In a further improved solution,
The energy storage power mother machine includes a main control module, a mother machine power supply input module, a first battery pack module, a first battery management module and a first output module;
Each energy storage power child machine includes a sub-control module, a child machine power supply input module, a second battery pack module, a second battery management module and a second output module;
After the energy storage power mother machine is connected with the energy storage power child machine, the main control module on the energy storage power mother machine is connected with the sub-control module on the energy storage power child machine to control the sub-control module;
The child machine power supply input module may be connected with the first output module to achieve the power supply for the mother machine and charging and energy storage for the child machine. The child machine power supply input module is a magnetic suction charging interface.

In a further improved solution, the first output module includes a DC 12V output interface, a child machine power supply output interface and an USB-A/C/PD output interface, and the child machine power supply interface is configured to connect with the child machine power supply input module for supplying power.

In a further improved solution, the energy storage power mother machine further includes any one or more of a rapid charge module, an inverter output module and a first display module.

In a further improved solution, the second output module includes an USB-A/C/PD output interface; and each energy storage power child machine further includes any one or more of a wireless charge module, an automobile starting module, a lighting module, a second display module and a WIFI hot spot module.

In a further improved solution, the energy storage power mother machine further includes an APP communication module that may be connected with an external energy storage management APP, and the APP control module can send the information of the energy storage power mother machine and the energy storage power child machines to the energy storage management APP in real time, and be controlled by the energy storage management APP.

A control method for an energy storage child-mother machine, including the following steps:

The energy storage power mother machine may accept the external power supply and store energy, the energy storage power mother machine may acquire itself electric quantity information in real time, and the energy storage power mother machine is connected to the external power supply circuit for charging the energy storage power mother machine when detecting that itself electric quantity does not reach the preset electric quantity saturation.

The energy storage power mother machine may acquire the electric quantity and voltage information of each energy storage power child machine after being in power supply and communication connection with the energy storage power child machine, and the energy storage power mother machine lightens power supply marks of the mother machine and the child machine when detecting that the electric quantity of the energy storage power child machine does not reach the preset electric quantity saturation, and a power supply circuit is turned on to charge the energy storage power child machine.

When the voltage of the energy storage power child machine reaches a preset value, or the electric quantity of the energy storage power mother machine is lower than the preset value, the energy storage power mother machine disconnects the circuit charging the energy storage power child machine, and at the same time turns off the power supply marks of the mother machine and the child machine.

In a further improved solution, when the energy storage power child machine is in power supply and communication connection with the energy storage power mother machine, the energy storage power mother machine may collect a battery temperature of the energy storage power child machine in real time, and when detecting that a temperature of the second battery module exceeds a preset temperature, the energy storage power mother machine disconnects the circuit charging the energy storage power child machine, and at the same time sends out an alarm signal.

In a further improved solution,

The energy storage power mother machine may judge whether the external power supply circuit is connected so as to charge the energy storage power mother machine according to itself electric quantity, as well as the number and electric quantity of the energy storage power child machines connected to the energy storage power mother machine;

The energy storage power mother machine may judge whether to charge N energy storage power child machines connected to the energy storage power mother machine continuously according to itself electric quantity, as well as the number and electric quantity of the energy storage power child machines connected to the energy storage power mother machine.

In a further improved solution,

The wireless charge main control module, the WIFI hot spot main control module and the lighting main control module may be arranged in the energy storage power mother machine;

To acquire a wireless charge function of the energy storage power child machine, the wireless charge main control module of the energy storage power mother machine needs to control the starting of the wireless charge module of the energy storage power child machine; and to turn off the wireless charge function of the energy storage power child machine, the wireless charge main control module of the energy storage power mother machine needs to control the stopping of the wireless charge module of the energy storage power child machine;

To acquire a WIFI hot spot function of the energy storage power child machine, the WIFI hot spot main control module of the energy storage power mother machine needs to control the starting of the WIFI hot spot module of the energy storage power child machine; and to turn off the WIFI hot spot function of the energy storage power child machine, the WIFI hot spot main control module of the energy storage power mother machine needs to control the stopping of the WIFI hot spot module of the energy storage power child machine;

To acquire a lighting function of the energy storage power child machine, the lighting main control module of the energy storage power mother machine needs to control the starting of the lighting module of the energy storage power child machine; and to turn off the lighting function of the energy storage power child machine, the lighting main control module of the energy storage power mother machine needs to control the stopping of the lighting module of the energy storage power child machine;

The present disclosure has the following beneficial effects: the present disclosure provides an energy storage child-mother machine system, which includes an energy storage power mother machine and a plurality of energy storage power child machines matching with the energy storage power mother machine. Under a normal state, the energy storage power mother machine is connected to the power and stores energy, so as to charge the energy storage power child machines; specifically, charge slots or charge positions may be arranged on the energy storage power mother machine, then the energy storage power child machines may be placed on the charge slots or the charge positions. When going out, only the energy storage power child machines can be detached, the charged energy storage child machines are carried out, so users are convenient to supply power by the energy storage power child machines at any time. The energy storage power child machines can be used when needed, put back for charging, so as to adapt to the using demands in different scenarios; and the using flexibility is greatly improved, and the energy storage power child machines are convenient and intelligent.

### BRIEF DESCRIPTION OF THE DRAWINGS

The above and/or additional aspects and advantages of the present disclosure are obvious and easy to understand in combination with the description for the embodiments in the drawing below, wherein:

FIG. 1 is a system block diagram I for an energy storage child-mother machine system.

FIG. 2 is a system block diagram II for an energy storage child-mother machine system.

### DETAILED DESCRIPTION OF THE EMBODIMENTS

The embodiments of the present disclosure are described in details in this part, the better embodiments of the present disclosure are presented in the drawings, which are configured to supplement the description of the written part of the specification by figures, so that people can directly and vividly understand each technical feature and the whole technical solution, but not be understood as limitations to the present disclosure.

In the description of the present disclosure, the meaning of “a plurality” is more than two, “greater than”, “less than”, “exceeding” and the like are understood as excluding the original number, and “above”, “below”, “within” and the like are understood as including the original number. The described “first” and “second” are merely used for distinguishing technical features, instead of being understood as indicating or implying relative importance or impliedly indicating the quantity of the showed technical features or impliedly indicating the precedence relationship of the showed technical features.

In the description of the present disclosure, it is understood that orientation or position relationships indicated by the terms “upper”, “lower”, “front”, “rear”, “left”, and “right”, and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

In the present disclosure, unless specific regulation and limitation otherwise, terms “set”, “install”, “connect” and the like should be generally understood, for example, may a direct connection, or an indirect connection through an intermediation, may be a fixed connection, or a detachable connection, or integrated, may a mechanical connection, and may an internal connection of two elements or an interactive relationship of two elements. Those of ordinary skill in the art may reasonably determine the specific meaning of the terms in the present disclosure in combination with the specific contents of the technical solution.

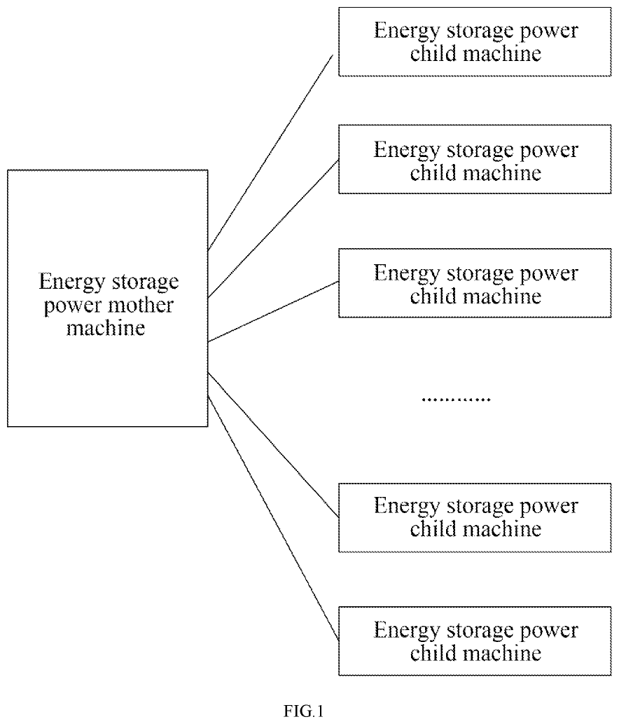

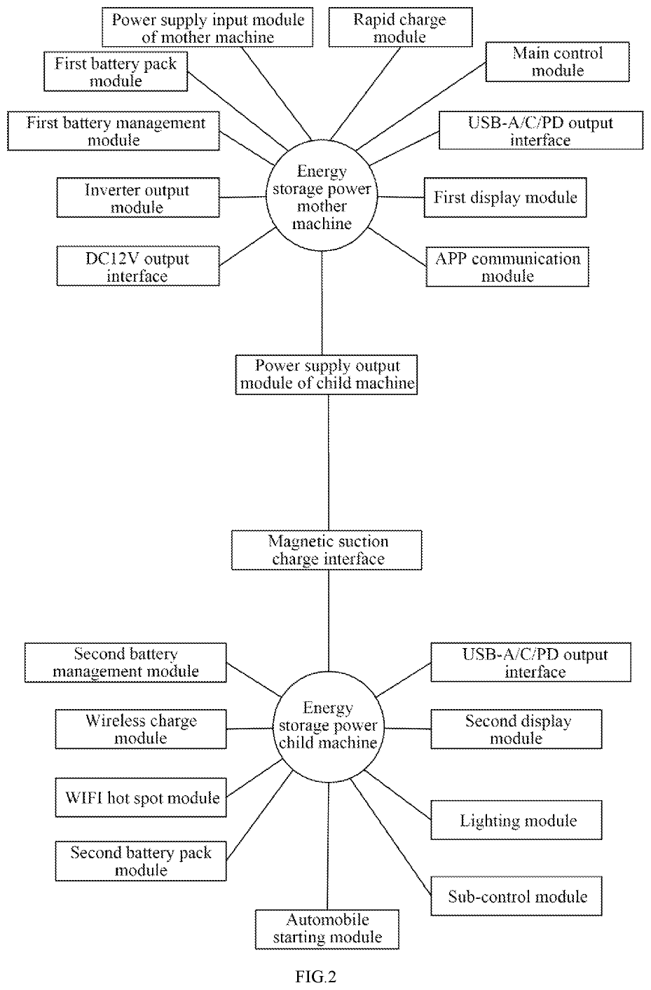

An energy storage child-mother machine system, as shown in FIG. 1 and FIG. 2, including an energy storage power mother machine and N energy storage power child machines corresponding to the energy storage power mother machine, and N is greater than or equal to 1; any one of the energy storage power child machines may be disconnected or in power supply and double-directional communication connection with the energy storage power child machine, and the energy storage power mother machine and the energy storage power child machines may be subjected to the self-battery management; and the energy storage power mother machine may be connected to an external circuit for charging and storing energy and supply power to the energy storage power child machines after connecting to the energy storage power child machines, and the energy storage power child machines may accept the power supply and store energy, and supply power to the external circuit.

The present disclosure provides an energy storage child-mother machine system, which includes an energy storage power mother machine and a plurality of energy storage power child machines matching with the energy storage power mother machine. Under a normal state, the energy storage power mother machine is connected to the power and stores energy, so as to charge the energy storage power child machines; specifically, charge slots or charge positions may be arranged on the energy storage power mother machine, then the energy storage power child machines may be placed on the charge slots or the charge positions. When going out, only the energy storage power child machines can be detached, the charged energy storage child machines are carried out, so users are convenient to supply power by the energy storage power child machines at any time. The energy storage power child machines can be used when needed, put back for charging, so as to adapt to the using demands in different scenarios; and the using flexibility is greatly improved, and the energy storage power child machines are convenient and intelligent.

In a further improved solution, as shown in FIG. 2,

The energy storage power mother machine includes a main control module, a mother machine power supply input module, a first battery pack module, a first battery management module and a first output module;

Each energy storage power child machine includes a sub-control module, a child machine power supply input module, a second battery pack module, a second battery management module and a second output module;

After the energy storage power mother machine is connected with the energy storage power child machine, the main control module on the energy storage power mother machine is connected with the sub-control module on the energy storage power child machine to control the sub-control module;

The child machine power supply input module may be connected with the first output module to achieve the power supply for the mother machine and charging and energy storage for the child machine. The child machine power supply input module is a magnetic suction charging interface;

The first output module includes a DC 12V output interface, a child machine power supply output interface and an USB-A/C/PD output interface, and the child machine power supply interface is configured to connect with the child machine power supply input module for supplying power.

In specific use, the first battery management module performs battery management on the first battery pack module, and the second battery management module performs battery management on the second battery pack module; the mother-child control is performed between the energy storage power mother machine and the energy storage power child machines through the connection control between the main control module and the sub-control module; charging and discharging connection is achieved between the energy storage power mother machine and the energy storage power child machines by the child machine power supply output interface and the child machine power supply input module, and the energy storage power child machines are placed into the slots of the energy storage power mother machine to achieve the automatic magnetic suction charging by using a magnetic suction charging method; and in addition, with a plurality of output interfaces, the energy storage power mother machine can achieve the power supply for a plurality of interfaces in addition to the power supply for the energy storage child machines.

In one embodiment, as shown in FIG. 2, the energy storage power mother machine further includes one or more of a rapid charge module, an inverter output module and a first display module, to achieve the rapid charging for the energy storage power mother machine, and then the direct current is inverted into the alternating current for outputting. The work data, such as electric quantity, output voltage, output current, input voltage, input current, working temperature and the like of the energy storage power mother machine may be displayed in real time through the first display module.

In one embodiment, as shown in FIG. 2, the second output module includes an USB-A/C/PD output interface; and the energy storage power child machine further includes any one or more of a wireless charge module, an automobile starting module, a lighting module, a second display module and a WIFI hot spot module. Thus it can be seen that, with a plurality of functions, the energy storage power child machines may not only achieve the output power supply of a multifunctional interface, but also connect the positive and negative anodes of an automobile battery when the automobile cannot be ignited by an automobile starting module, thereby performing ignition and achieving the effect of self-rescue in emergency situations. Wireless charge equipment is subjected to wireless power supply by the wireless power supply module, the lighting module is used for lighting, and the energy storage power child machines are used as the mobile network hot spots by the WIFI hot spot module. In the actual use, WIFI hot spot slots are arranged on the energy storage power child machines, after WIFI hot spot card are inserted into the WIFI hot spot slots, this function may be achieved. The work data, such as electric quantity, output voltage, output current, input voltage, input current, working temperature and the like of the energy storage power child machines may be displayed in real time through the second display module.

In one embodiment, as shown in FIG. 2, the energy storage power mother machine further includes an APP communication module that may be connected with an external energy storage management APP, and the APP control module can send the information of the energy storage power mother machine and the energy storage power child machine to the energy storage management APP in real time, and be controlled by the energy storage management APP, so that users are convenient to manage and check an APP mobile terminal.

The present disclosure is a control method for an energy storage child-mother machine, including the following steps:

The energy storage power mother machine may accept the external power supply and store energy, the energy storage power mother machine may acquire itself electric quantity information in real time, and the energy storage power mother machine is connected to the external power supply circuit for charging the energy storage power mother machine when detecting that itself electric quantity does not reach the 100% of preset electric quantity saturation.

The energy storage power mother machine may acquire the electric quantity and voltage information of the energy storage power child machine after being in power supply and communication connection with the energy storage power child machine, and the energy storage power mother machine lightens power supply marks of the mother machine and the child machine when detecting that the electric quantity of the energy storage power child machine does not reach the 100% of preset electric quantity saturation, and a power supply circuit is turned on to charge the energy storage power child machine.

When the voltage of the energy storage power child machine reaches 16.8V, or the electric quantity of the energy storage power mother machine is lower than 5%, the energy storage power mother machine disconnects the circuit charging the energy storage power child machine, and at the same time turns off the power supply marks of the mother machine and the child machine.

In one embodiment, when the energy storage power child machine is in power supply and communication connection with the energy storage power mother machine, the energy storage power mother machine may collect a battery temperature of the energy storage power child machine in real time, and when detecting that a temperature of the second battery module exceeds 60 DEG C, the energy storage power mother machine disconnects the circuit charging the energy storage power child machine, and at the same time sends out an alarm signal.

In one embodiment,

The energy storage power mother machine may judge whether the external power supply circuit is connected so as to charge the energy storage power mother machine according to itself electric quantity, as well as the number and electric quantity of the energy storage power child machines connected to the energy storage power mother machine, then the electric quantity prediction management, the realization of the electric quantity and the intelligent charge/discharge management of the energy storage power mother machine itself can be achieved.

The energy storage power mother machine may judge whether to charge N energy storage power child machines connected to the energy storage power mother machine continuously according to itself electric quantity, as well as the number and electric quantity of the energy storage power child machines connected to the energy storage power mother machine, then the electric quantity prediction management, the realization of the electric quantity and the intelligent charge/discharge management of the energy storage power child machines can be achieved.

In one embodiment,

The wireless charge main control module, the WIFI hot spot main control module and the lighting main control module may be arranged in the energy storage power mother machine;

To acquire a wireless charge function of the energy storage power child machine, the wireless charge main control module of the energy storage power mother machine needs to control the starting of the wireless charge module of the energy storage power child machine; and to turn off the wireless charge function of the energy storage power child machine, the wireless charge main control module of the energy storage power mother machine needs to control the stopping of the wireless charge module of the energy storage power child machine;

To acquire a WIFI hot spot function of the energy storage power child machine, the WIFI hot spot main control module of the energy storage power mother machine needs to control the starting of the WIFI hot spot module of the energy storage power child machine; and to turn off the WIFI hot spot function of the energy storage power child machine, the WIFI hot spot main control module of the energy storage power mother machine needs to control the stopping of the WIFI hot spot module of the energy storage power child machine;

To acquire a lighting function of the energy storage power child machine, the lighting main control module of the energy storage power mother machine needs to control the starting of the lighting module of the energy storage power child machine; and to turn off the lighting function of the energy storage power child machine, the lighting main control module of the energy storage power mother machine needs to control the stopping of the lighting module of the energy storage power child machine;

According to the above description, the energy storage power child machines are needed to be started at the energy storage power mother machine if the wireless power supply function, the WIFI hot spot function and the lighting function are used. The energy storage power child machines can be turned on when the energy storage power mother machine sends out a starting signal to the energy storage power child machines, and the energy storage power mother machine implements the unified overall management.

Although the present disclosure is described in details with reference to the abovementioned embodiments. It is apparent that those skilled in this art may make respective change and modification without deviating from the principle, spirit and scope of the present disclosure limited in claims. Therefore, the detail description for the embodiments of the present disclosure is only used for explaining rather than limiting the present disclosure, and the protection scope is limited by the contents of the claims.

What is claimed is:

1. An energy storage child-mother machine system, wherein the system comprises an energy storage power mother machine and N energy storage power child machines corresponding to the energy storage power mother machine, and N is greater than or equal to 1; any one of the energy storage power child machines is disconnected or in power supply and double-directional communication connection with the energy storage power child machine, and the energy storage power mother machine and the energy storage power child machines are subjected to the self-battery management; and the energy storage power mother machine is connected to an external circuit for charging and storing energy and supply power to the energy storage power child machines after connecting to the energy storage power child machines, and the energy storage power child machines accept the power supply and store energy, and supply power to the external circuit.

2. The energy storage child-mother machine system according to claim 1, wherein
the energy storage power mother machine comprises a main control module, a mother machine power supply input module, a first battery pack module, a first battery management module and a first output module;
each energy storage power child machine comprises a sub-control module, a child machine power supply input module, a second battery pack module, a second battery management module and a second output module;
after the energy storage power mother machine is connected with the energy storage power child machines, the main control module on the energy storage power mother machine is connected with the sub-control modules on the energy storage power child machines to control the sub-control module; and
the child machine power supply input module may be connected with the first output module to achieve the power supply for the mother machine and charging and energy storage for the child machine.

3. The energy storage child-mother machine system according to claim 2, wherein the first output module comprises a DC 12V output interface, a child machine power supply output interface and an USB-A/C/PD output interface, and the child machine power supply interface is configured to connect with the child machine power supply input module for supplying power.

4. The energy storage child-mother machine system according to claim 3, wherein the energy storage power mother machine further comprises any one or more of a rapid charge module, an inverter output module and a first display module.

5. The energy storage child-mother machine system according to claim 2, wherein the second output module comprises an USB-A/C/PD output interface; and the energy storage power child machine further comprises any one or more of a wireless charge module, an automobile starting module, a lighting module, a second display module and a WIFI hot spot module.

6. The energy storage child-mother machine system according to claim 2, wherein the energy storage power mother machine further comprises an APP communication module that may be connected with an external energy storage management APP, and the APP control module may send the information of the energy storage power mother machine and the energy storage power child machine to the energy storage management APP in real time, and be controlled by the energy storage management APP.

7. A control method for an energy storage child-mother machine system, comprising the following steps:
the energy storage power mother machine may accept the external power supply and store energy, the energy storage power mother machine may acquire itself electric quantity information in real time, and the energy storage power mother machine is connected to the external power supply circuit for charging the energy storage power mother machine when detecting that itself electric quantity does not reach the preset electric quantity saturation;
the energy storage power mother machine may acquire the electric quantity and voltage information of the energy storage power child machine after being in power supply and communication connection with the energy storage power child machine, and the energy storage power mother machine lightens power supply marks of the mother machine and the child machine when detecting that the electric quantity of the energy storage power child machine does not reach the preset electric quantity saturation, and a power supply circuit is turned on to charge the energy storage power child machine; and
when the voltage of the energy storage power child machine reaches a preset value, or the electric quantity of the energy storage power mother machine is lower than the preset value, the energy storage power mother machine disconnects the circuit charging the energy storage power child machine, and at the same time turns off the power supply marks of the mother machine and the child machine.

8. The control method for the energy storage child-mother machine system according to claim 7, wherein
when the energy storage power child machine is in power supply and communication connection with the energy storage power mother machine, the energy storage power mother machine may collect a battery temperature of the energy storage power child machine in real time, and when detecting that a temperature of the second battery module exceeds a preset temperature, the energy storage power mother machine disconnects the circuit charging the energy storage power child machine, and at the same time sends out an alarm signal.

9. The control method for the energy storage child-mother machine system according to claim 8, wherein
the energy storage power mother machine may judge whether the external power supply circuit is connected so as to charge the energy storage power mother machine according to itself electric quantity, as well as the number and electric quantity of the energy storage power child machines connected to the energy storage power mother machine; and
the energy storage power mother machine may judge whether to charge N energy storage power child machines connected to the energy storage power mother machine continuously according to itself electric quantity, as well as the number and electric quantity of the energy storage power child machines connected to the energy storage power mother machine.

10. The control method for the energy storage child-mother machine system according to claim 8, wherein
the wireless charge main control module, the WIFI hot spot main control module and the lighting main control module may be arranged in the energy storage power mother machine;
to acquire a wireless charge function of the energy storage power child machine, the wireless charge main control module of the energy storage power mother machine needs to control the starting of the wireless charge module of the energy storage power child machine; and to turn off the wireless charge function of the energy storage power child machine, the wireless charge main control module of the energy storage power mother machine needs to control the stopping of the wireless charge module of the energy storage power child machine;
to acquire a WIFI hot spot function of the energy storage power child machine, the WIFI hot spot main control module of the energy storage power mother machine needs to control the starting of the WIFI hot spot module of the energy storage power child machine; and to turn off the WIFI hot spot function of the energy storage power child machine, the WIFI hot spot main control module of the energy storage power mother machine needs to control the stopping of the WIFI hot spot module of the energy storage power child machine; and
to acquire a lighting function of the energy storage power child machine, the lighting main control module of the energy storage power mother machine needs to control the starting of the lighting module of the energy storage power child machine; and to turn off the lighting function of the energy storage power child machine, the lighting main control module of the energy storage power mother machine needs to control the stopping of the lighting module of the energy storage power child machine.
